(19) United States
(12) Patent Application Publication
(10) Pub. No.: US 2018/0285888 A1
(43) Pub. Date: Oct. 4, 2018

(54) Method for Generating at least one Identifier of at least one Article

(71) Applicant: Robert Bosch GmbH, Stuttgart (DE)

(72) Inventors: Christian Staebler, Leinfelden-Echterdingen (DE); Christopher Michael Barker, Stuttgart (DE); Daniel Vesenmaier, Leinfelden-Echterdingen (DE); Florian Esenwein, Leinfelden-Echterdingen (DE); Joachim Schadow, Stuttgart (DE); Maja Hofmann, Wannweil (DE); Michael Briesenick, Stuttgart (DE); Simon Kutz, Bruehl (DE)

(21) Appl. No.: 15/927,950

(22) Filed: Mar. 21, 2018

(30) Foreign Application Priority Data
Mar. 29, 2017 (DE) 10 2017 205 314.3

(51) Int. Cl. G06Q 30/00

(52) U.S. Cl. CPC G06Q 30/0185

(57) ABSTRACT

A method for generating at least one identifier of at least one article, in particular a power tool, includes sensing at least one usage parameter and/or at least one article parameter of the article with at least one sensing unit. The method further includes creating with at least one computing unit, in dependence on the at least one sensed usage parameter and/or the at least one sensed article parameter, a certificate of the article, and/or assigning the article to at least one person.

This application claims priority under 35 U.S.C. § 119 to patent application no. DE 10 2017 205 314.3, filed on Mar. 29, 2017 in Germany, the disclosure of which is incorporated herein by reference in its entirety.

### BACKGROUND

A method for generating at least one identifier of at least one article has already been proposed, wherein, in at least one method step, at least one usage parameter and/or at least one article parameter of the article are/is sensed by means of at least one sensing unit.

### SUMMARY

The disclosure is based on a method for generating at least one identifier of at least one article, in particular a power tool, wherein, in at least one method step, at least one usage parameter and/or at least one article parameter of the article are/is sensed by means of at least one sensing unit.

It is proposed that, in at least one method step, by means of at least one computing unit, in dependence on the at least one sensed usage parameter and/or the at least one sensed article parameter, a certificate of the article is created, and/or the article is assigned to at least one person.

The method design according to the disclosure makes it possible to improve the efficiency of management of the article. Further, advantageously, user convenience can be improved, in that registering can be simplified and/or a warranty of the article is made possible, even in the case of loss of a proof of purchase. In particular, by means of the certificate, a warranty can be matched to a state, in particular a state of abrasion, in particular an elapsed operating time, of the article. Moreover, it becomes possible for a user to be offered an option to extend a warranty for the article, depending on the state of abrasive wear of the article. Particularly advantageously, it is possible to take account of a delay, occurring in the course of production, distribution and/or storage of the article of warranty, that may occur in the course of storage of the article, for example in a sales warehouse, and/or in the course of transport, such as may occur, for example, during shipping from a production site to a sales location, and/or during delivery of the article. Further, advantageously, product security can be improved, since the authenticity of the article can be certified by means of the certificate, such that, advantageously, distinguishing of fakes can be improved. Particularly preferably, the assignment, in the case of servicing and/or repair, makes it possible to take account of an activity of the person, and of further articles assigned to the person, such that, in particular, simultaneous servicing of the articles can be avoided. Further, advantageously, the at least one article parameter and/or the at least one usage parameter can be specifically stored, processed and/or summarized by means of the certificate. In particular, a data set that is specific to the provision of services such as, for example, maintenance, can be easily read out using the certificate. Moreover, advantageously, transmission of parameters of differing parameter types can be simplified.

An “identifier” is to be understood to mean, in particular, a link that is characteristic to an article and that, in particular, is designed for processing in a computing unit. In particular, the identifier is designed to link the article to the certificate and/or to the person. The identifier may be, in particular, a digital identifier such as, for example, an identification code that is designed, in particular, for registering the article in a stock of articles. “Designed” is to be understood to mean, in particular, specially programmed, configured and/or equipped. That an object is designed for a particular function, is to be understood to mean, in particular, that the object performs and/or executes this particular function in at least one application state and/or operating state. An “article” is to be understood to mean, in particular, an object designed at least to execute at least one function and that, in particular for the purpose of executing the function, preferably can at least be guided and/or carried by a person. The article is in particular a tool, preferably a hand-held tool. Particularly preferably, the article is a power tool, preferably a hand-held power tool, in particular electrically operated and preferably portable. A “portable power tool” is to be understood here to mean, in particular, a power tool that can be transported by an operator without the use of a transport machine. The portable power tool has, in particular, a mass of less than 40 kg, preferably less than 10 kg, and particularly preferably less than 5 kg. A “hand-held power tool” is to be understood to mean, in particular, a machine for performing work on workpieces, but advantageously a power drill, a hammer drill and/or percussion hammer, a saw, a plane, a screwdriver, a router, a sander, an angle grinder, a garden appliance and/or a multifunction tool. For example, the article may also be a drill, a chisel, a percussion drill, a sander, a lawn mower or the like. Alternatively, the article may also be an item of work clothing such as, for example, a safety jacket, or an electronic work device such as, for example, a smartphone.

A “sensing unit” is to be understood to mean, in particular, a unit that has at least one sensor for sensing the at least one usage parameter and/or the at least one article parameter. The sensing unit is preferably designed to sense a plurality of usage parameters and/or a plurality of article parameters, and for this purpose may comprise a plurality of sensors. In particular, the sensing unit may be part of the article. Alternatively, the sensing unit may be realized separately from the article, and preferably be part of an external unit. The sensing unit, and/or in particular a sensor group of the sensing unit, comprises in particular, as a sensor, at least one photosensor, preferably a CCD (charge-coupled device) sensor, at least one force sensor, at least one pressure sensor, at least one acceleration sensor, in particular at least one Hall sensor, at least one location sensor, in particular at least one GPS (global positioning system) sensor, at least one current sensor, at least one voltage sensor, at least one resistance sensor, at least one power sensor, at least one energy sensor, at least one vibration sensor, at least one oscillation sensor, at least one sound-pressure sensor, in particular at least one piezo sensor, at least one distance sensor, in particular at least one laser and/or infrared sensor, at least one humidity sensor or the like. In particular, it is conceivable that differing sensing units, differing sensors and/or sensor groups, in particular of one same sensing unit, are provided for the purpose of sensing differing parameters and/or characteristic quantities.

The external unit may be, in particular, a mobile, in particular electrical, unit such as, for example, a wearable, a laptop, a tablet, a smartphone, a smartwatch or the like, an in particular a sensor module and/or a communication module. Alternatively, the external unit may be part of a company headquarters, a network, in particular a computer network, a server, in particular a server network, preferably a cloud. A “usage parameter” is to be understood to mean, in particular, a characteristic value that represents usage of the article and/or that is at least indirectly, preferably directly, correlated to usage of the article. Preferably, the usage parameter is a usage timepoint, a usage duration, a number of usages, a usage location, a usage intensity, in particular a usage load, preferably a usage wear, and/or or a usage state of the article. Moreover, the usage parameter could be a parameter of a usage routine that can be performed upon initial operation. A usage routine may comprise, in particular, a particular sequence of functions, key combinations or the like. In particular, in the case of creation of the certificate and/or assignment of the article to a person, at least two, preferably a plurality, of these usage parameters, in particular of differing parameter types, are used. The usage parameter may be determined, in particular, from at least one device characteristic value such as, for example, from a current, a voltage, a rotational speed, an acceleration, in particular a vibration, a power, an orientation, a number of switch-on operations, a number of switch-off operations, a run-time intrinsic to the article, a state of abrasion of structural elements, a switching time, a rotational-speed behavior, a temperature and/or the like as well as, in particular, triggering of at least one safety function such as, for example, a kickback. For example, the usage duration may be generated on the basis of the respective number of switch-on operations, number of switch-off operations and/or run-time inherent to the article. Moreover, it is conceivable for the usage parameter to be a usage wear. This could be determined, for example, on the basis of a state of abrasive wear. The usage timepoint may be, in particular, a first-operation timepoint. The usage duration may be, in particular, a duration, in particular a total usage duration, of components and/or structural elements and/or of the entire hand-held power tool and/or of the item of work clothing, such as, for example, of a motor, in particular at least one direction of operation of the motor, at least one electronics unit, at least one tool, such as, for example, at least one screwdriver bit, at least one drill bit, at least one chisel or the like, at least one energy storage device such as, for example, at least one accumulator and/or at least one battery, and specifically preferably at least one charging duration and/or at least one discharging duration, at least one overload operating duration or the like. Moreover, the number of usages may be, in particular, a number of switch-on and/or switch-off operations, a number of charging and/or discharging cycles of the energy storage device, a number of triggered inverter switching operations of an electronics unit and/or of a motor, a number of usages of tools, a number of triggered protective functions such as, for example, a kickback, a restart and/or a reset, a number of incorrect usages such as, for example, as a result of falling and/or improper storage, or a number of error messages. The usage intensity is, in particular, a preferably average, percentage and/or maximum power of the hand-held power tool and/or of the item of work clothing, at least one current intensity, at least one voltage intensity, a phase shift between current and voltage, and/or a preferably average and/or maximum rotational speed or rotational-speed change and/or an overload. Moreover, the usage intensity may be at least one oscillation intensity, at least one vibration intensity, at least one sound emission intensity, a preferably average, percentage and/or maximum torque, a preferably average, percentage and/or maximum efficiency, at least one contact-pressure force, in particular at least one contact-pressure force intensity and/or a percussion energy. The usage temperature is, in particular, an average, percentage and preferably maximum temperature, preferably a temperature gradient, and specifically in particular before, after and/or during operation of the hand-held power tool and/or of the item of work clothing, and specifically in particular of the motor, the energy storage device, the tool such as, for example, a drill bit, screwdriver bit and/or chisel, or of an accessory and/or of an environment of the hand-held power tool and/or of the item of work clothing. The usage state is, in particular, a state of the hand-held power tool and/or of the item of work clothing, such as, for example, an error state, an inactive state, a work state, a charge state of the energy storage device and/or a state of a derating of at least one electrical component of the hand-held power tool and/or of the item of work clothing, such as, for example, of an electronics unit, of the energy storage device and/or of a motor. The usage wear is, in particular, an alteration, over time, of at least one structural element of the hand-held power tool and/or of the item of work clothing and/specifically in particular of a tool and/or of an electrical component, such as, for example, of an internal resistance of the energy storage device, of a charging and/or discharging curve of the energy storage device and/or of a derating curve.

An “article parameter” is to be understood to mean, in particular, a location, a completion timepoint, a production parameter, a maintenance parameter such as, in particular, a maintenance timepoint, a specification of a component of the article that is to be serviced, and/or a distribution parameter. A “distribution parameter” is to be understood to mean, in particular, a characteristic value that characterizes a distribution such as, in particular, a sale and/or hiring of the article and/or that is correlated to the latter, such as, in particular, a purchase timepoint, preferably a purchase date, a proof of purchase, an item of vendor information such as, preferably, a sales location, an item of owner information, an item of previous-owner information, a hiring timepoint, preferably a hiring date, a proof of hiring, an item of hiring information such as, preferably, a hiring location or an item of hirer information or the like. A “production parameter” is to be understood to mean, in particular, a characteristic value that characterizes production of the article and/or that is correlated to the latter, such as, in particular, a serial number, a production timepoint, preferably a production date, an item of production information such as, preferably, a production location or the like. A “computing unit” is to be understood to mean, in particular, a unit having a preferably wireless information input, an information processing system and an information output. Advantageously, the computing unit has at least one processor, a memory, input and output means, further electrical components, an operating program, closed-loop control routines, open-loop control routes and/or calculation routines. In particular, the method for generating the identifier of the article is stored on the computing unit. Preferably, the components of the computing unit are arranged on a common printed circuit board and/or advantageously arranged in a common housing. The computing unit is, in particular, part of the article. Alternatively, the computing unit may be realized separately from the article, and preferably be part of an external unit. A “certificate” is to be understood to mean, in particular, an identifier that characterizes the article and that, in particular, comprises properties of the article and/or items of information belonging to the article. Preferably, the certificate groups together at least one usage parameter and/or article parameter, preferably at least two usage parameters and/or article parameters, and particularly preferably at least two differing parameter types such as, in particular, at least one usage parameter and at least one article parameter. Moreover, it is conceivable that at least one certificate and at least one further certificate can be combined to form at least one main certificate. Alternatively or additionally, at least one authorization parameter and/or one encryption parameter are/is assigned to the certificate. The authorization parameter comprises, in particular, an authorization for storing, altering and/or retrieving the certificate. The encryption parameter comprises, in particular, at least one key for encrypting and/or decrypting the certificate.

One design of the certificate is dependent, in particular, on a combination of the at least one article parameter and/or the at least one usage parameter, by means of which the certificate is created. Preferably, the certificate is an operation certificate, an authenticity certificate, and/or preferably a replacement certificate that is designed to supplement and/or replace, at least temporarily or entirely, a guarantee certificate such as, for example, a proof of purchase, a guarantee document or the like. Moreover, it is conceivable for the certificate to be realized as a production certificate that groups together at least one production parameter, as at least one test certificate that groups together at least one usage intensity parameter, as at least one registration certificate that groups together parameters of an identity of the article and/or of a person assigned to the article, as at least one first-operation certificate that groups together, in particular, parameters of a first operation, as at least one maintenance certificate that groups together, in particular maintenance parameters of the article, as at least one safety certificate that groups together parameters of operational safety of the article, as at least one lifetime certificate that groups together, in particular, usage duration parameters, and/or as at least one disposal certificate. It is conceivable that, with use of the replacement certificate, it is possible to dispense entirely with a standard proof of purchase or guarantee document. Alternatively or additionally, the certificate could be designed for, in particular, cashless purchase of the article, of accessories and/or for booking the provision of services such as, for example, maintenance, servicing and/or repair or the like, in particular in electronic trading such as, in particular, via an online portal, Internet trading, e-commerce or the like, and could advantageously be used therein as a digital proof of purchase. For example, the certificate may be as a card number of a SIM (subscriber identity module) card that, in particular, is integrated in the article, and/or GSM (global system for mobile communications) card, and/or as an IMEI (international mobile station equipment identity) number stored in a memory unit of the article.

It is additionally proposed that, in at least one method step, at least by means of the computing unit, at least on the basis of the at least one usage parameter and/or the at least one article parameter, at least one first-operation timepoint of the article is determined, and the certificate is created in dependence thereon. A “first-operation timepoint” is to be understood to mean, in particular, a timepoint of first operation of an article by an end customer. The first operation is, in particular, different from a test operation that may be conducted, for example, during production and/or at the time of sale. The first operation may be identified, for example, if the usage parameter exceeds a usage limit value beyond which a first operation is assumed. The limit value in this case is set in such a manner that, in a test operation, the usage parameter does not exceed the limit value. If the usage parameter is, for example, a usage duration, a first operation may be ascertained if a usage limit value, in particular a usage duration, is exceeded. Preferably, the first-operation timepoint may be determined by means of a further usage parameter such as, for example, a usage timepoint. Advantageously, in the creation of the replacement certificate, the first-operation timepoint may replace a purchase timepoint. Advantageously, identification of a first operation can be improved. In particular, it is possible to avoid a test operation such as, for example, during production and/or at the time of sale of the article, being confused with a first operation. Further, advantageously, a first-operation timepoint that differs from a purchase timepoint can be taken into account in the creation of the replacement certificate, thereby, in particular, enabling a warranty to be extended. Particularly preferably, it is possible to provide a warranty that is matched to usage and that, in particular, extends beyond a statutory warranty.

Furthermore, it is proposed that, in at least one method step, at least by means of the computing unit, on the basis of at least one distribution parameter and/or production parameter stored in a memory unit, the determined first-operation timepoint is verified. The memory unit may be, in particular, an internal memory unit of the article. Alternatively, the memory unit may be realized such that it is different and/or separate from the article. In particular, the memory unit may be part of an external unit. It is conceivable for the memory unit to be part of the computing unit. It is conceivable for the distribution parameter and/or the production parameter to be sensed by means of the sensing unit and, in particular, to be stored in the memory unit. In particular, for this purpose the memory unit may be realized as a part of the article, preferably as a memory chip such as, for example, a SIM card, as a GSM card, and/or as part of an electronics unit of the article, of external electronics unit or the like. Preferably, the distribution parameter and/or the production parameter are/is stored in the memory unit during production and/or at the time of distribution, in particular at the time of sale and/or hire. In particular, it is conceivable that the distribution parameter and/or the production parameter can be stored in the memory unit by a user for the purpose of verifying the first-operation timepoint. Advantageously, a first-operation timepoint can be taken into account in creation of the replacement certificate. Further, advantageously, incorrect determination of a first-operation timepoint can be avoided. Particularly advantageously, misuse or manipulation of distribution parameters and/or production parameters can be avoided.

Furthermore, it is proposed that, in at least one method step, at least by means of the computing unit, on the basis of the at least one distribution parameter and/or the at least one production parameter and the determined first-operation timepoint, an age of the article is calculated, and the certificate is created in dependence thereon. In particular, the usage parameter can be used to determine a usage period that is calculated from the difference of the age of the article and the period between the purchase timepoint and a respective usage timepoint, in particular a first-operation timepoint, and that is taken into account in creation of the certificate. Particularly preferably, the first-operation timepoint replaces a purchase timepoint, in particular in the context of a warranty, in the event that the purchase timepoint differs significantly from the first-operation timepoint. That the first-operation timepoint “differs significantly from the purchase timepoint” is to be understood to mean, in particular, that the purchase timepoint and the first-operation timepoint are separated by at least five hours, preferably at least fifteen hours, and particularly preferably by at least thirty hours. In particular, in determination of a time separation between an operation timepoint and a purchase timepoint, a correction factor, that is specific to the article and that is dependent on an average usage duration of the article, in particular per day, can be weighted. In particular, the correlation factor comprises a value of one hour per day, and particularly preferably of half of one hour per day. Advantageously, a replacement certificate can be created that can exclude periods of time such as, for example, of transport and/or storage, from a warranty period, thereby enabling an overall warranty period to be extended.

It is additionally proposed that, in at least one method step, at least by means of the computing unit, at least on the basis of the at least one usage parameter and/or the at least one article parameter, at least one application of the article is determined, and the certificate is created in dependence thereon. In particular, in the case of a changing application, the certificate can be adapted in the course of a lifetime of the article. In particular, a main application of the article can be determined. A “main application” in this context is to be understood to mean, in particular, an application of which the period of application comprises at least 50%, preferably at least 70%, and particularly preferably at least 90% of a total period of application of the article. The replacement certificate can be matched specifically to the requirement of the application, at the time of its creation and/or during a run-time. In particular, additional services, matched to particular applications, in particular main applications, may be offered. Moreover, applications for which the article is not designed can be excluded from the scope of warranty of the replacement certificate.

Furthermore, it is proposed that, in at least one method step, at least by means of the sensing unit, within at least one time interval, in particular during a warranty period of the certificate, usage parameters and/or article parameters are sensed, which are processed by the computing unit for the purpose of adapting the created certificate. Advantageously, continuous adaptation of the certificate during a lifetime of the article can be achieved. Further, advantageously, continuous monitoring of the article can be effected.

It is additionally proposed that, in at least one method step, for the purpose of creating the certificate and/or for the purpose of assigning, at least by means of the sensing unit, at least one usage parameter, realized at least as a usage timepoint, a usage duration, a number of usages, a usage location, a usage intensity, and/or as a usage state of the article, is sensed. Advantageously, simple usage parameter sensing can be achieved.

It is furthermore proposed that, in at least one method step, by means of the computing unit, the article is assigned to the person in dependence on at least one identification parameter of the person, an allocation of usage rights for the person being at least initiated in the case of a repeated assignment by means of the same identification parameter, at least by means of the computing unit. An “identification parameter” is to be understood to mean, in particular, a characteristic value that characterizes a person and/or a user account already linked to the person, a further article such as, for example, a wearable, a laptop, a smartphone, a tablet, a smartwatch or the like as well as, in particular, an item of work clothing. In particular, the identification parameter may be an identification number assigned to the user, a PIN, a finger-print, an iris image or the like. In particular, it is conceivable that, in the case of a repeated assignment with the same identification parameter, a person can be characterized as a main user and/or as a contact partner for management, maintenance, servicing and/or repair of the article, and preferably main usage rights can be assigned to this person A “main user” is to be understood, in particular, to mean a person who uses the article for at least 50%, preferably at least 70%, and particularly preferably at least 90% of a total usage time of the article. Advantageously, assignment to a person can be improved and, in particular, made particularly secure. It is additionally conceivable for a certificate to comprise the identification parameter, for the purpose of assignment of a person.

It is additionally proposed that, in at least one method step, the at least one usage parameter and/or the at least one article parameter are/is transmitted, by means of a, in particular wireless, communication unit, to at least one external unit, in particular an external unit comprising the computing unit, for the purpose of creating the at least one certificate and/or for the purpose of assigning the article to a person. A “communication unit” is to be understood to mean, in particular, a unit designed at least for electronic, preferably wireless, information transmission. The communication unit is designed, in particular, for authorized and/or encrypted information transmission that, in particular, is dependent on the at least one authorization parameter and/or the at least one encryption parameter of the certificate. In particular, the communication unit is designed for information transmission by radio telephony such as, for example, via W-LAN, Bluetooth, near-field communication, transponder such as, for example, by means of an RFID chip, wireless networks having a low data volume such as, in particular, ZigBee, by means of data transfer protocols such as, in particular, ANT+, LoRa, NBIoT or the like, and/or for optical information transmission such as, for example, infrared. In particular, the communication unit may be part of the article and/or of the external unit. It is conceivable for the communication unit to be part of a wearable, a laptop, a smartphone, a tablet, a smartwatch or the like, and/or of work clothing. Advantageously, flexible transmission of usage parameters can be achieved.

It is additionally proposed that, in at least one method step, the at least one created certificate and/or the assignment of the article to the person is transmitted to at least one external unit by means of a, in particular wireless, communication unit. Advantageously, the certificate can be created inside the article. Preferably, an amount of computing work of the external unit can be reduced. In addition, provision of the certificate can be simplified.

In a further aspect of the disclosure, a system is proposed for generating at least one identifier, in particular by means of the preceding method, having at least one article, in particular a power tool, having at least one sensing unit that is designed to sense at least one usage parameter and/or at least one article parameter of the article, and having at least one computing unit that is designed to create a certificate of the article and/or to assign the article to at least one person in dependence on the at least one sensed usage parameter and/or the at least one article parameter. Advantageously, a system can be provided that has improved characteristics with regard to efficiency of management of the article.

The method and/or system according to the disclosure are/is not designed in this case to be limited to the application and embodiment described above. In particular, the method and/or system according to the disclosure may have individual elements, component parts and units that differ in number from a number stated herein, in order to fulfill an operating principle described herein. Moreover, in the case of the value ranges specified in this disclosure, values lying within the stated limits are also to be deemed as disclosed and applicable in any manner.

### BRIEF DESCRIPTION OF THE DRAWINGS

Further advantages are disclosed by the following description of the drawing. An exemplary embodiment of the disclosure is represented in the drawing. The drawing, the description and the claims contain numerous features in combination. Persons skilled in the art will also expediently consider the features individually and combine them to create appropriate further combinations.

There are shown in:

FIG. 1 a part of a system for generating an identifier, in a schematic view,

FIG. 2 a schematic flow diagram of an exemplary method for generating an identifier, and

FIG. 3 a further schematic flow diagram of the method for generating the identifier.

### DETAILED DESCRIPTION

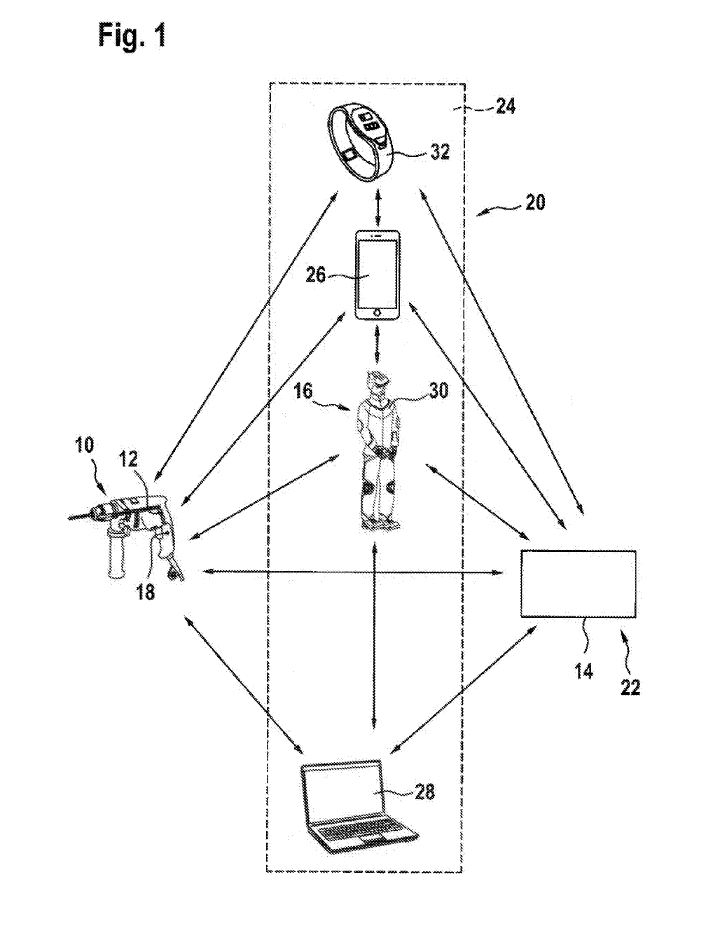

FIG. 1 shows a schematic representation of a system for generating at least one identifier of at least one article 10. The system comprises at least the article 10. In the present case, the article 10 is realized as a hand-held power tool, and specifically in particular, as a percussion drill. Alternatively or additionally, the article 10 may also be realized as any article 10 considered appropriate by persons skilled in the art, such as, for example, as an orbital sander, a garden appliance or the like. They system may additionally have articles 10 that differ in number from the number represented here, and in particular the articles may differ from each other. In particular, a number of articles 10 may constitute a stock of articles, the system being designed for management of the stock of articles. The system is then also designed to generate identifiers of the respective number of articles 10.

The system comprises a memory unit 18. In the present case, the memory unit 18 is part of the article 10. The memory unit 18 is an internal memory unit 18 of the article 10. Alternatively, the memory unit 18 may also be part of an external unit 22.

At least one distribution parameter is stored in the memory unit 18. In the present case, the distribution parameter is a purchase timepoint, in particular a purchase date. Further distribution parameters may be also stored in the memory unit 18, such as, for example, a sales location, a sales identification number or the like. At least one production parameter of the article 10 is also stored in the memory unit 18. The production number is a serial number. At least one further production parameter is also stored in the memory unit 18. The further production parameter is a production date.

The system comprises at least one sensing unit 12. In the present case, the sensing unit 12 is part of the article 10. The sensing unit 12 is an internal sensing unit 12 of the article 10. Alternatively, the sensing unit 12 may also be part of an external unit 22. The sensing unit 12 is designed to sense at least one usage parameter of the article 10. The sensing unit 12 is also designed to sense a further usage parameter. The usage parameter is stored in the memory unit 18. In the present case, the usage parameter is a usage timepoint. The further usage parameter is stored in the memory unit 18. The further usage parameter is a usage duration. Alternatively or additionally, a usage location, a usage intensity and/or a usage state of the article 10 may also be sensed as a usage parameter, and/or stored in the memory unit 18. A usage limit value is also stored in the memory unit 18. The usage limit value is provided for comparison with the usage parameter. A created certificate may also be stored in the memory unit 18. The certificate is stored by means of an authorization parameter assigned to the certificate. The authorization parameter grants at least one access right and/or processing right for the certificate and/or for at least one parameter of parameters that are grouped together in the certificate.

The system comprises the external unit 22. In the present case, the external unit 22 is realized as a server. Alternatively or additionally, the external unit 22 may be a computer network, a company headquarters and/or a cloud.

The system comprises at least one computing unit 14. In the present case, the computing unit 14 is part of the external unit 22. Alternatively, the computing unit 14 may also be part of the article 10. The computing unit 14 is designed to create a certificate of the article 10. The computing unit 14 creates the certificate in dependence on the at least the usage parameter and in particular the further usage parameter. The computing unit 14 is designed, in particular, to determine a first-operation timepoint, on the basis of the usage parameter and, in particular, on the basis of the further usage parameter. The first-operation timepoint is a usage timepoint at which a usage duration exceeds a predefined usage limit value. Alternatively or additionally, the computing unit 14 is designed to assign the article 10 to at least one person 16.

The system also comprises at least one communication unit 20. The communication unit 20 is realized as a wireless communication unit 20. The communication unit 20 connects the sensing unit 12 and/or the memory unit 18 to the external unit 22. The communication unit 20 is designed to transmit at least one usage parameter, in particular between the article 10 and the external unit 22. The communication unit 20 is also designed to transmit the distribution parameters and/or the production parameters. The communication unit 20 is designed for encrypted transmission. The communication unit 20 encrypts the certificate and/or the parameters grouped together to create the certificate and/or the parameters grouped together in the certificate with at least one encryption parameter assigned to the certificate. Alternatively or additionally, the communication unit 20 may be designed to transmit the created certificate. In the present case, the communication unit 20 comprises at least one mobile unit 24. The mobile unit 24 is assigned by a person 16 who uses the article 10. The mobile unit 24 is preferably realized by a smartphone 26. The mobile unit 24 may also be realized by a laptop 28, a network, in particular a W-LAN network, by an item of work clothing and/or a smartwatch 32. Alternatively, it is also conceivable for the communication unit 20 to be part of the article 10 and/or of the external unit 22.

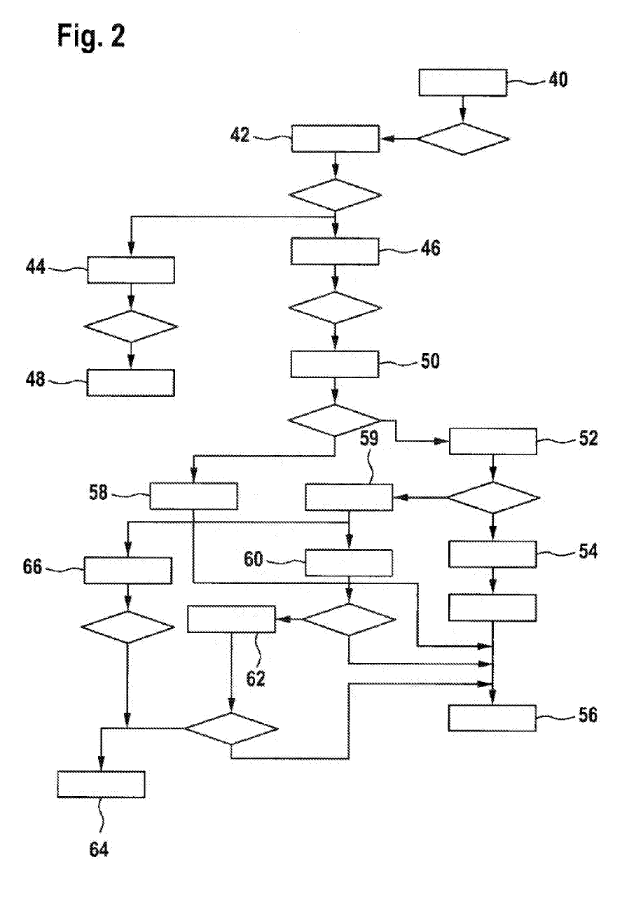

The system is designed to execute a method for generating an identifier. FIG. 2 shows a schematic flow diagram of the method for generating the at least one identifier. Creation of at least one certificate is also described in the method. In the present case, the certificate is a first-operation certificate.

The method comprises a method step 40. In the method step 40, the article 10 is connected to the external unit 22 by means of the communication unit 20. The article 10 is registered in a stock of articles. The parameters stored in the memory unit 18, in particular the usage parameter, the distribution parameter, the further distribution parameter, the production parameter and/or the further production parameter, are read out by the external unit 22. The computing unit 14 compares whether at least one of the parameters, in particular the production parameter, and specifically the serial number of the article 10, is already stored. Alternatively or additionally, the production parameter may be input manually and/or sensed by means of the sensing unit 12, in particular by means of image acquisition. If the article 10, and specifically in particular with the associated production parameter, is present in the stock of articles, the procedure is concluded. Alternatively, in particular for an already registered article 10, usage parameters may be sensed, in particular continuously, by means of the sensing unit 12, within at least one time interval, which usage parameters are processed by the computing unit 14 for the purpose of adapting a created certificate.

The method comprises a method step 42. The method step 42 is performed if the production parameters, distribution parameters, usage parameters and/or the associated article 10 are/is not yet stored and/or registered in the external unit 22. In the method step 42, it is inquired whether the article 10 is already assigned to the person 16. Alternatively, it may also be inquired whether the article 10 is assigned to a user, an owner, a main user and/or a company.

The method comprises a method step 44. If the article 10 is not yet assigned to the person 16, an assignment is effected in the further method step 44. It is also inquired in the further method step 44 whether the article 10 with its production parameter is already assigned to a further person 16, a further user, a further owner, a further main user and/or a further company.

The method also comprises a further method step 48. If the article 10 is not yet assigned, by means of its production parameter, to a further person 16, the article 10 is assigned in the method step 48.

The method comprises a further method step 46. In the method step 48 it is inquired whether a certificate is to be created for the article 10.

The method comprises a method step 50. The method step 50 is executed if a certificate is to be created. In the method step 50 the certificate of the article 10 is created by means of the computing unit 14, at least in dependence on the at least one sensed usage parameter. At least one application, in particular a main application, of the article 10 may also be determined on the basis of the at least one usage parameter, and the certificate created in dependence thereon. A first-operation timepoint of the article 10 is also determined by means of the computing unit 14, at least one the basis of the at least one usage parameter, and specifically in particular on the basis of the usage timepoint, and of the further usage parameter, and specifically in particular of the usage duration. If, for example, in the usage of the article 10, the further usage parameter exceeds a limit value, then the usage parameter at the time of exceeding the limit value is assumed as the first-operation timepoint. In addition, the certificate is created, or adapted to the first-operation timepoint, in dependence on the first-operation timepoint. An age of the article 10 is also determined in the method step 50. For this purpose, the first-operation timepoint is verified by means of the computing unit 14, on the basis at least of the distribution parameter and/or production parameter stored in the memory unit 18. The age is determined from the difference of the first-operation timepoint and of the further production parameter. For example, an error may be output if a first-operation timepoint precedes a purchase timepoint of the distribution parameter.

The method comprises a further method step 52. The further method step 52 is performed if the first-operation timepoint differs by more than five hours from the purchase timepoint. In the method step 52 a further distribution parameter, specifically in particular a purchase timepoint, is interrogated. In the method step 52 it is inquired whether a proof of purchase exists.

The method comprises a further method step 54. The method step 54 is performed if the proof of purchase exists. Alternatively, it is conceivable that no proof of purchase exists or that it has been lost, such that for this case the certificate can replace the proof of purchase. The proof of purchase is read-in in the method step 54. In particular, it is conceivable for the proof of purchase to be read-in by means of the sensing unit 12. The further distribution parameter is read-out from the proof of purchase.

The method comprises a further method step 56. In the method step 56 the sensed parameters are transmitted to the external unit 22 by means of the communication unit 20. The registration of the article 10 in the stock of articles is concluded, in that a replacement certificate is created for the article 10 and/or the article 10 is assigned to the person 16. In the present case, the replacement certificate replaces a proof of purchase.

The method comprises a further method step 58. In the method step 58, if the first-operation timepoint differs from the purchase timepoint by less than five hours, the first-operation timepoint is equated to the purchase timepoint. After the method step 58, the method step 56 is performed.

The method comprises a further method step 59. The method step 59 is performed if no proof of purchase exists. The purchase timepoint is input by the person 16.

The method comprises a further method step 60. The input purchase timepoint is verified by means of the first operation state. If the input purchase timepoint substantially matches the first-operation timepoint, the method step 56 is performed.

The method comprises a further method step 62. The further method step 62 is performed if the stated purchase timepoint differs substantially from the first-operation timepoint, and specifically in particular by more than five hours. The first-operation timepoint is proposed as the purchase timepoint. The person 16 may accept the first-operation timepoint as the purchase timepoint. If the first-operation timepoint is accepted as the purchase timepoint, the method proceeds with the method step 56.

The method comprises the further method step 64. The method step 64 is performed if the proposal to adopt the first-operation timepoint as the purchase timepoint is not accepted. In the method step 64, it is output that the article 10 cannot be registered. Moreover, additionally or alternatively, a connection to a service centre may be established.

The method comprises a further method step 66. The further method step 66 is performed after the method step 58, in particular as an alternative to the method step 60. In the method step 66, the purchase timepoint is verified on the basis of the production parameter, in particular the serial number. If the serial number has not yet been issued, for example at the stated purchase timepoint, an error is identified. The method proceeds with the method step 64.

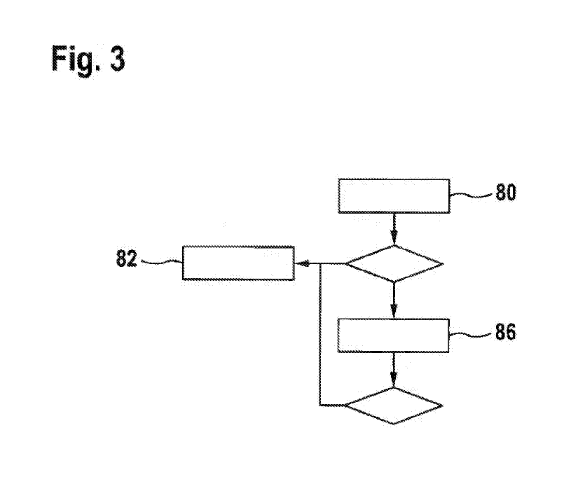

Further method steps of the method are shown in FIG. 3.

The method comprises a method step 80. In the method step 80, the article 10 is registered in a stock of articles. The article 10 is connected to the external unit 22 by means of the communication unit 20. The parameters stored in the memory unit 18, in particular the usage parameter, the distribution parameter, the further distribution parameter, the production parameter and/or the further production parameter, are read out. In addition, by means of the computing unit 14, the article 10 is assigned to the person 16 in dependence on at least one identification parameter of the person 16. The computing unit 14 calculates whether there is already a main user stored for the article 10.

The method comprises a further method step 82. If a main user has already been stored, a method step 82 is performed. In the method step 82 the computing unit 14 calculates whether there is already a central contact partner stored for management, maintenance, servicing, and/or repair. If no contact partner has yet been stored, the assigned person 16 is stored as the contact partner.

The method comprises a further method step 86. In a method step 86, if there is a main user, the main user is stored as the contact partner. For example, a person 16 repeatedly assigned to the article 10 may be stored as the main user. For this purpose, assignment of usage rights for the person 16 is initiated in the case of repeated assignment by means of the same identification parameter, at least by means of the computing unit 14.

As represented on the basis of the exemplary method in FIGS. 2 and 3, differing parameters can be grouped together to form a certificate. In the following, the creation of the certificate from FIG. 2 is summarized exemplarily. The creation of further certificates is also explained in the following on the basis of further examples.

In the present case, the certificate is realized as a first-operation certificate. The certificate is created on the basis of the usage parameter. The usage parameter is a usage timepoint. The certificate is created at least on the basis of the further usage parameter. The further usage parameter is a usage duration. The first-operation timepoint is determined at least on the basis of the usage parameter and the further usage parameter. The first-operation timepoint is a usage timepoint at which a usage duration exceeds a predefined usage duration limit value. Alternatively, the first-operation timepoint may be determined on the basis of a usage routine such as, for example, a key combination.

Alternatively or additionally, at least one further certificate may be created in the method. At least one first further certificate is also created. In the present case, the first further certificate is realized as a production certificate. The first further certificate is created at least one the basis of a device parameter. The device parameter is a production parameter, and specifically in particular a production timepoint such as, for example, a date and/or a time of day at which the article is produced, and in particular completed. In addition, the first further certificate is created from at least one further article parameter. The further article parameter in the present case is a production parameter, and specifically in particular a serial number and/or a bare-tool number of the article.

Alternatively or additionally, at least one second further certificate may be created in the method. In the present case, the second further certificate is realized as a test certificate. The second further certificate is created at least one the basis of a first further usage parameter. The first further usage parameter is a usage intensity such as, for example, a maximum rotational speed. The second further certificate is created at least one the basis of a second further usage parameter. The second further usage parameter is a test timepoint such as, for example, a time of day at which a test is performed and, in particular, at which the second further usage parameter is sensed.

Alternatively or additionally, at least one third further certificate may be created in the method. In the present case, the third further certificate is realized as a servicing certificate. The third further certificate is a maintenance certificate. The third further certificate is created at least one the basis of a first further article parameter, in particular a maintenance parameter. The first further article parameter is a maintenance timepoint. In addition, the third further certificate is created on the basis of a second further article parameter, in particular a maintenance parameter, and specifically in particular on the basis of a specification of a component of the article requiring maintenance. It is conceivable that the third further certificate and the second further certificate can be combined to form one main certificate such as, for example, an operation certificate.

Alternatively or additionally, at least one fourth further certificate may be created in the method. In the present case, the fourth further certificate is realized as a distribution certificate. The fourth further certificate is created at least on the basis of a third further article parameter. The third further article parameter is a distribution parameter such as, for example, an item of purchaser information. In addition, the fourth further certificate is created on the basis of a fourth further article parameter, in particular a maintenance parameter, and specifically in particular on the basis of a purchase timepoint of the article 10.

It is conceivable that a plurality of certificates, in particular all certificates, combine to form a main certificate such as, for example, a time-history certificate and/or lifetime certificate. The main certificate may comprise all certificates created over the history of the article, preferably in the course of a lifetime of the article.

What is claimed is:

1. A method for generating at least one identifier of at least one article comprising:
sensing at least one usage parameter and/or at least one article parameter of the article with at least one sensing unit; and
creating with at least one computing unit, in dependence on the at least one sensed usage parameter and/or the at least one sensed article parameter, a certificate of the article and/or assigning the article to at least one person.

2. The method according to claim 1, further comprising:
determining, at least with the computing unit, at least based on the at least one usage parameter, at least one first-operation timepoint of the article, and creating the certificate in dependence thereon.

3. The method according to claim 2, further comprising:
verifying, at least with the computing unit, based on at least one distribution parameter stored in an internal memory unit of the article, the determined first-operation timepoint.

4. The method according to claim 2, further comprising:
calculating, at least with the computing unit, based on the at least one distribution parameter and the determined first-operation timepoint, an age of the article, and creating the certificate in dependence thereon.

5. The method according to claim 1, further comprising:
determining, at least with the computing unit, at least based on the at least one usage parameter and/or the at least one article parameter, at least one application of the article, and creating the certificate in dependence thereon.

6. The method according to claim 1,further comprising:
sensing, at least with the sensing unit, within at least one time interval, usage parameters and/or article parameters that are processed by the computing unit to adapt the created certificate.

7. The method according to claim 1, further comprising:
sensing, for creating the certificate and/or for assigning, at least with the sensing unit, at least one usage parameter, realized as a usage timepoint, a usage duration, a number of usages, a usage location, a usage intensity, and/or as a usage state of the article.

8. The method according to claim 1, further comprising:
assigning, with the computing unit, the article to the person in dependence on at least one identification parameter of the person; and
initiating an allocation of usage rights for the person in a case of a repeated assignment by the same identification parameter, at least with the computing unit.

9. The method according to claim 1, further comprising:
transmitting the at least one usage parameter and/or the at least one article parameter with a communication unit to at least one external unit comprising the computing unit to create the at least one certificate and/or to assign the article to a person.

10. The method according to claim 1, further comprising:
transmitting the at least one created certificate and/or the assignment of the article to the person to at least one external unit with a wireless communication unit.

11. The method according to claim 1, wherein article is a power tool.

12. A system for generating at least one identifier, comprising:
at least one article having at least one sensing unit configured to sense at least one usage parameter and/or at least one article parameter of the article; and
at least one computing unit configured to create a certificate of the article and/or to assign the article to at least one person in dependence on the at least one sensed usage parameter and/or the at least one sensed article parameter.

13. The system according to claim 12, further comprising:
a wireless communication unit configured to transmit the identifier to an external unit.

14. The system according to claim 12, wherein the at least one article is a power tool.
